(19) United States
(12) Patent Application Publication
(10) Pub. No.: US 2013/0253995 A1
(43) Pub. Date: Sep. 26, 2013

(54) METHOD FOR REWARDING PARTICIPANTS OF A VOTING EVENT

(71) Applicant: Tony LIN, Taoyuan City (TW)

(72) Inventor: Tony LIN, Taoyuan City (TW)

(21) Appl. No.: 13/827,524

(22) Filed: Mar. 14, 2013

Related U.S. Application Data
(60) Provisional application No. 61/615,690, filed on Mar. 26, 2012.

(51) Int. Cl. G07C 13/00

(52) U.S. Cl. CPC G07C 13/00
USPC 705/12

(57) ABSTRACT

A method for rewarding participants of a voting event is to be performed by a computing device, and includes: hosting the voting event for participation by the participants; presenting description information of candidates of the voting event; receiving inputs to vote from the participants, each of the inputs to vote corresponding independently to one of the candidates; selecting a winning candidate according to numbers of inputs to vote corresponding to the candidates; and providing a reward to the participants from which the inputs to vote corresponding to the winning candidate were received, the reward including beneficial information associated with the winning candidate.

### CROSS-REFERENCE TO RELATED APPLICATION

This application claims priority of U.S. Provisional Application No. 61/615,690, filed on Mar. 26, 2012.

### BACKGROUND OF THE INVENTION

1. Field of the Invention

The present invention relates to a method for rewarding participants of a voting event, more particularly to a method for providing beneficial information to participants of a voting event.

2. Description of the Related Art

Nowadays, more and more people rely on the Internet whenever they need information on such as products and services. Although most online shopping platforms, discussion forums, and information sources for such needs nowadays generally implement a mechanism through which users may post comments, rate, and discuss about a product and/or service, most users may be reluctant to make use of such a mechanism (e.g., a voting event) because such activities are generally time-consuming and non-rewarding.

### SUMMARY OF THE INVENTION

Therefore, an object of the present invention is to provide a method for encouraging user participation in an online voting event.

According to the present invention, a method for rewarding participants of a voting event that is associated with a plurality of candidates, each of which is associated with description information, is to be performed by a computing device, and includes the steps of:

a) hosting the voting event for participation by the participants;

b) presenting the description information of the candidates;

c) receiving inputs to vote from the participants, each of the inputs corresponding independently to one of the candidates;

d) selecting a winning candidate according to numbers of inputs to vote corresponding to the candidates and received from the participants; and

e) providing a reward to the participants from which the inputs to vote corresponding to the winning candidate were received, the reward including beneficial information associated with the winning candidate.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart showing steps of the first preferred embodiment of a method for rewarding participants of a voting event, according to the present invention;

FIG. 2 is a diagram showing an exemplary webpage corresponding to the first preferred embodiment; and

FIG. 3 is a diagram showing an exemplary webpage corresponding to the second preferred embodiment of the method according to the present invention.

### DETAILED DESCRIPTION OF THE PREFERRED EMBODIMENTS

Before the present invention is described in greater detail, it should be noted that like elements are denoted by the same reference numerals throughout the disclosure.

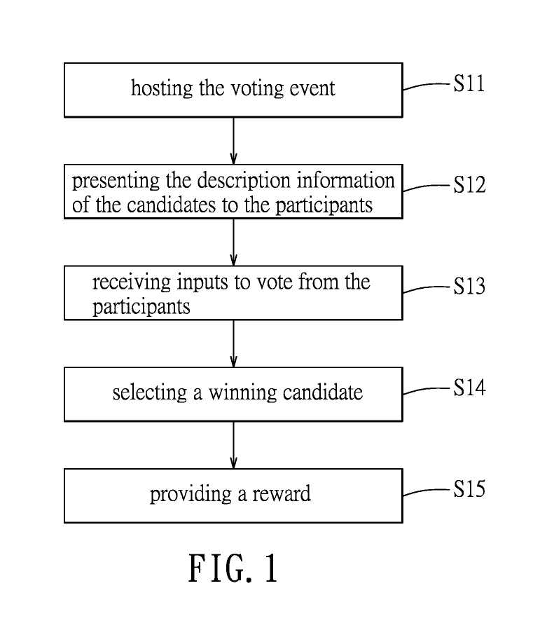

Shown in FIG. 1 is the first preferred embodiment of a method for rewarding participants of a voting event, according to the present invention. In this embodiment, the voting event is associated with first and second candidates (e.g., products or services offered by suppliers), each of which is associated with description information (e.g., commercial promotion information, free giveaway information, an image, a video, and combinations thereof) and is further associated with beneficial information (i.e., information that enables the participants to avail of the candidates). The method is to be performed preferably by a server device including a member database that includes a plurality of member profiles corresponding to the participants of the voting event, respectively. Each of the member profiles includes such as reward points, member pictures, member statistic information, and description associated with the corresponding one of the participants. The participants may be connected via a network (e.g., the Internet) to the server device through various client devices such as smartphones, personal computers, portable computers, and tablet personal computers.

In step S11, the server device, which is a computing device, is configured to host the voting event for participation by the participants through the client devices via the network.

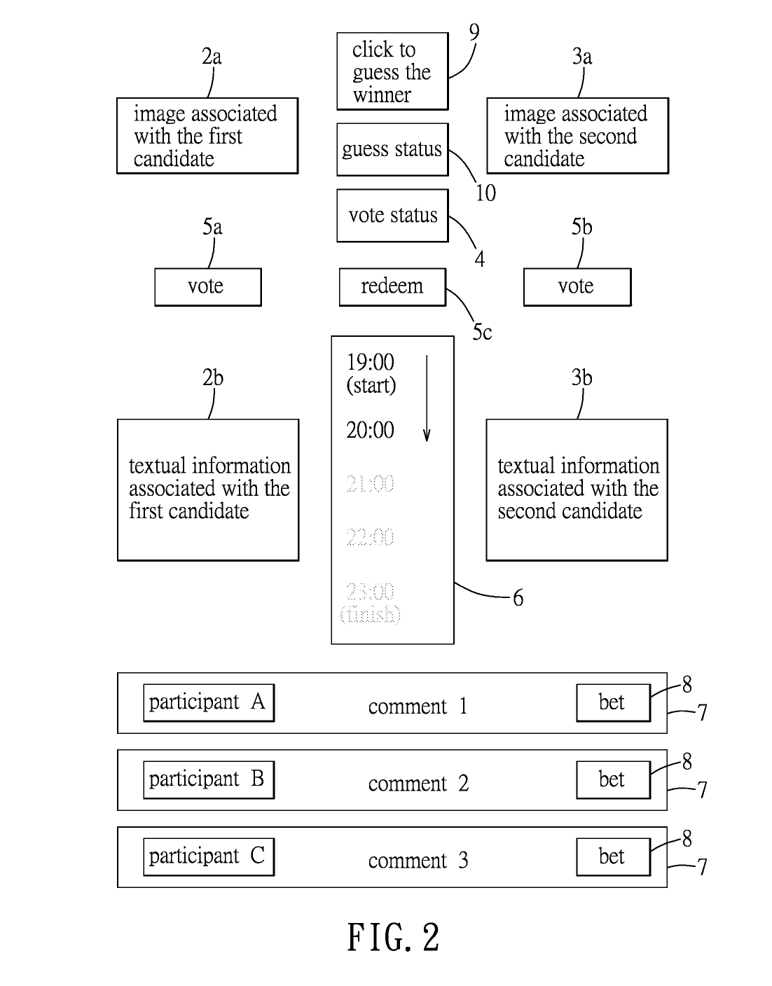

In step S12, the server device is configured to present the description information of the first and second candidates to the participants via such as a webpage. Shown in FIG. 2 is an exemplary webpage presented to the participants. The webpage includes first and second images 2a, 3a corresponding respectively to the first and second candidates, and first and second boxes 2b, 3b showing textual information corresponding respectively to the first and second candidates. The textual information may include such as brands, products, prices, dates, availability, addresses, and phone numbers. However, presentation of the description information is not limited to such, and may be otherwise in other embodiments. For example, the server device may be configured to present the description information to the participants via various smartphones applications operatively associated with the server device.

In step S13, the server device is configured to receive inputs to vote from the participants, each of the inputs corresponding independently to one of the candidates. In the exemplary webpage, each of the participants may provide the input to vote for one of the first and second candidates by clicking a corresponding one of first and second vote-buttons 5a, 5b of the webpage. In this embodiment, the server device is further configured to show a vote status of the voting event in a vote-status region 4 of the webpage during a predetermined count-down time before the voting event ends. The count-down time may range from 0 second to the duration of the voting event. In particular, the vote status includes, but is not limited to, a total number of the inputs to vote received by the server device, and, for each of the first and second candidates, a total number of the inputs to vote for the candidate. The vote-status region 4 may be omitted in other embodiments of this invention. Furthermore, each of the participants may redeem a predetermined number of the reward points for casting additional votes. The reward points may be purchased, or earned in such as the voting event, and may be redeemed for various benefits, such as online game time and discount coupons or vouchers.

In step S14, the server device is configured to select a winning candidate according to the numbers of inputs to vote corresponding to the candidates and received from the participants. In this embodiment, the winning candidate is the candidate to which a largest number of the inputs to vote received from the participants correspond when the voting event ends. However, selection of the winning candidate is not limited to such. For example, in a scenario involving three candidates, the winning candidate may be the candidate to which a smallest number of the inputs to vote correspond.

In step S15, the server device is configured to provide a reward to the participants from which the inputs to vote corresponding to the winning candidate were received (hereinafter referred to as the winning participants). The reward includes a predetermined number of reward points to be associated to the member profile of each of the winning participants, and the beneficial information associated with the winning candidate, which may include access information for coupons or vouchers corresponding to the winning candidate, such that the winning participants are able to avail of the winning candidate. Under circumstances where the winning candidate may be availed of by only a limited number of the winning participants, the winning participants that voted for the winning candidate at earlier times maybe assigned higher priorities to avail of the winning candidate. In other embodiments, the server device may be configured to provide more reward points to the winning participants from which the inputs to vote corresponding to the winning candidate were received at earlier times. As mentioned hereinabove, the reward points may be purchased, or earned through voting for the winning candidate. Other examples for which the reward points maybe redeemed include special profile icons and a higher membership status. However, applications of the reward points are not limited to such.

In this embodiment, the server device is configured to present the remaining time of the voting event in a time-status region 6 of the webpage, and to present respectively a plurality of comments received from some of the participants in a plurality of comment-regions 7 of the webpage. In the example of FIG. 2, the voting event is indicated to start at 19:00 and finish at 23:00.Preferably, the webpage may provide a mechanism through which the participants may bet against each other as to which of the candidates will be the winning candidate. Specifically, each of the comment-regions 7 includes a bet-button 8 clickable by any of the participants to trigger a bet of user-determined reward points (or system-determined reward points) with the participant, to which the comment-region 7 corresponds, as to which of the candidates will be the winning candidate. Such a function maybe useful for encouraging participation of the participants when disagreements exist among preferences of the participants.

In a modification of the first preferred embodiment, the server device is further configured to show a guess-button 9 in the webpage clickable by the participants to register respective guesses as to which of the candidates will be the winning candidate, as well as a guess-status region 10 preferably showing statistical information corresponding to the guesses. In comparison with the vote-status region 4, information shown in the guess-status region 10 merely serves a reference upon which the participants may independently determine which of the candidates will be the winning candidate. However, participants that clicked the guess-button 9 to register guesses may still be rewarded with a different reward.

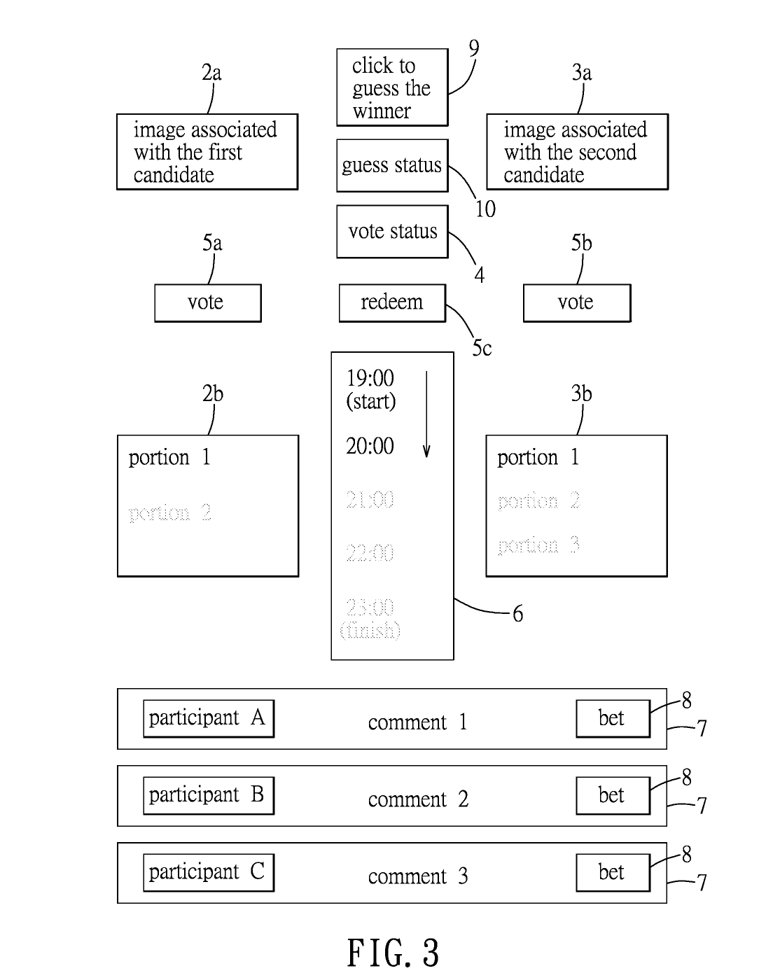

Referring to FIG. 3, the difference between the first and second preferred embodiments resides in that, in the second preferred embodiment, the description information of each of the candidates is divided into a respective number of portions for presentation to the participants at scheduled times. In this embodiment, the description information of the first candidate is divided into first and second portions for presentation to the participants at 19:00 and 21:00, respectively.

The description information of the second candidate is divided into first, second, and third portions for presentation to the participants at 19:00, 20:00, and 21:00, respectively. The number of portions into which the description information is divided, and the times at which the portions of the description information are presented, are not limited to such. As mentioned hereinabove, the server device may be configured to provide more reward points to the winning participants from which the inputs to vote were received at earlier times. For example, if the first candidate is the winning candidate, the server device may be configured to provide more reward points to the winning participants from which the inputs to vote were received before the second portion of the description information of the first candidate is presented compared to the winning participants from which the inputs to vote were received after the second portion of the description information of the first candidate is presented. Thus, the participants are encouraged to register their votes with the server device at earlier times.

Examples of the first and second candidates are described hereinafter. In a first example, the first and second candidates correspond to products from the same supplier. In a second example, the first and second candidates correspond to products from different suppliers. In a third example, the first and second candidates correspond to services from the same supplier. In a fourth example, the first and second candidates correspond to services from different suppliers. It is to be noted that the first and second candidates are not limited to such.

Furthermore, under circumstances where the winning candidate may be availed of by other than the winning participants, non-winning participants and non-participating spectators of the voting event may also avail of the winning candidate. For example, in step S15, the server device may be further configured to present the beneficial information to the non-winning participants and the non-participating spectators, in addition to the winning participants, after a predetermined delay time has elapsed. In addition, under circumstances where the voting event results in a draw, both the first and second candidates may be availed of by the participants. Moreover, in other embodiments, the candidates may include more than two candidates. Throughout the voting event, statistical information may be gathered for analysis.

In another modification, the server device may be further configured, in step S15, to show a redeem-button 5c in the webpage that is clickable only by each of the participants and the spectators who may avail of the winning candidate so as to generate a corresponding entry in an offer-redemption database associated with the winning participant. The entries in the offer-redemption database may be outputted for provision to the supplier of the winning candidate for reference during redemption of the product or the service to which the winning candidate corresponds.

In summary, through providing the winning participants with the reward points and/or the beneficial information, the preferred embodiments of a method for rewarding participants of a voting event, according to the present invention, are able to achieve the effects of increased participant involvement and hence webpage views.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for rewarding participants of a voting event, the voting event being associated with a plurality of candidates each of which is associated with description information, said method being performed by a computing device and comprising the steps of:
a) hosting the voting event for participation by the participants;
b) presenting the description information of the candidates to the participants;
c) receiving inputs to vote from the participants, each of the inputs corresponding independently to one of the candidates;
d) selecting a winning candidate according to numbers of inputs to vote corresponding to the candidates and received from the participants; and
e) providing a reward to the participants from which the inputs to vote corresponding to the winning candidate were received, the reward including beneficial information associated with the winning candidate.

2. The method as claimed in claim 1, the candidates being products or services offered by suppliers, wherein the beneficial information enables the participants to avail of the winning candidate.

3. The method as claimed in claim 2, wherein the beneficial information includes access information for one of a coupon and a voucher corresponding to the winning candidate.

4. The method as claimed in claim 1, wherein the winning candidate is the candidate to which a largest number of the inputs to vote received from the participants correspond.

5. The method as claimed in claim 1, the description information being divided into a plurality of portions, wherein step b) includes presenting the portions of the description information of the candidates to the participants at predetermined times, respectively.

6. The method as claimed in claim 1, wherein step e) further includes providing the reward to participants other than the participants from which the inputs to vote corresponding to the winning candidate were received.
